(19) United States
(12) Patent Application Publication
(10) Pub. No.: US 2015/0013719 A1
(43) Pub. Date: Jan. 15, 2015

(54) CLEANING DEVICE AND METHOD

(71) Applicant: CGG SERVCES SA, Massy Cedex (FR)

(72) Inventors: Raphael MACQUIN, Montrouge (FR); Jean-Baptiste HUBERT, Quimper (FR); Behzad VAHIDA, Saint Michel Sur Orge (FR)

(73) Assignee: CGG SERVCES SA, Massy Cedex (FR)

(21) Appl. No.: 14/136,650

(22) Filed: Dec. 20, 2013

Related U.S. Application Data
(60) Provisional application No. 61/844,578, filed on Jul. 10, 2013.

(51) Int. Cl. G01V 13/00

(52) U.S. Cl. CPC G01V 13/00
USPC 134/6; 15/246

(57) ABSTRACT

A cleaning device for cleaning a marine element towed in water and related methods are provided. The cleaning device is configured to follow a bypass rail attached to the marine element when an obstacle is encountered along the marine element. Thus, the cleaning device passes the entire marine element, from one end to the other, irrespective of the nature of the obstacle. The cleaning device includes a cleaning unit for cleaning the marine element.

### BACKGROUND

1. Technical Field

Embodiments of the subject matter disclosed herein generally relate to cleaning devices for marine equipment and, more particularly, to cleaning devices capable of passing obstacles located along the marine equipment.

2. Discussion of the Background

Marine seismic surveying investigates and maps the structure and character of geological formations under a body of water using reflection seismology. Reflection seismology is a method of geophysical exploration especially helpful in the oil and gas industry. In marine reflection seismology, the depth and horizontal location of features causing reflections of seismic waves are evaluated by measuring the time it takes for the seismic wave to travel to receivers. These features may be associated with subterranean hydrocarbon reservoirs.

A typical marine seismic surveying system is illustrated in FIG. 1. A vessel 100 tows a seismic source 102 and plural streamers 106, each streamer carrying an array of seismic receivers 104 (e.g., hydrophones, geophones, accelerometers, or a combination of sensors). It is desirable to maintain the streamers at predetermined horizontal cross-line distances (i.e., along an axis perpendicular to the towing direction T), and at predetermined depths (e.g., 10 m) relative to the water surface 108. Seismic source 102 is configured to generate a seismic wave 110 that propagates downward (down, up and vertical being defined relative to gravity) toward the seafloor 120 and penetrates formations 125 under seafloor 120 until it is eventually reflected at noncontiguous locations such as 122a and 122b. The reflected seismic waves 130a and 130b propagate upward and can be detected by one of receivers 104 on streamer 106. Based on the data collected by receivers 104, an image of the subsurface formation is generated by further analyses of the collected data.

To maintain the streamers at a desired position (i.e., such as to have predetermined cross-line distances and predetermined depths), conventionally, a head float 140 and a tail buoy 150 are attached to the streamer. Position control devices 155 (e.g., birds) may be attached to the streamer, every 300 m, to control the streamer's position. Other devices (not shown) may be attached to the streamer, e.g., a streamer recovery device.

Significant amounts of bio-fouling settlement accumulate on the exterior surface of streamers and other seismic system components. These accumulations can obscure the reflected seismic wave and significantly increase streamer drag. The rate of accumulation and the impact of bio-fouling and other contaminants depend on factors, among others, such as geographic location, water temperature, and the season. The gooseneck barnacle is the most common bio-fouling organism found on marine streamers.

Cleaning such contaminants from the streamer exterior is desirable and beneficial. For example, a cleaning device 160 may be moved along the streamer to clean contaminants from its exterior.

A conventional cleaning device, such as the one disclosed in U.S. Pat. No. 7,754,018, typically includes one or more cleaning elements (e.g., brushes) and a mechanism configured to attach and to roll the cleaning device along the streamer in order to clean its exterior. The cleaning device may include buoyant bodies.

A conventional cleaning device 165 described in U.S. Pat. No. 7,145,833 and illustrated in FIG. 2 has two vanes (e.g., 170a and 170b) attached to a cylindrical body 175 formed by two half-cylinders 177 engaged on one side by hinges 179 and on another by any suitable releasable fastener (not shown). Brushes 180 are attached inside the body 175 via inserts 185 to reach the outer surface of the streamer 106. The vanes are angled with respect to the body's longitudinal axis to provide both thrust and torque to the body 175.

Most conventional cleaning devices are passive and are moved relative to the streamer by the water flow. They are deployed at the front of the streamer (i.e., close to the towing vessel) and picked up at the end of the streamer, after a cleaning operation along the streamer, assuming that no obstacles are present along the streamer. While this was the case in the past, modern seismic systems have, as discussed with reference to FIG. 1, many birds 155 located along the streamer. A bird is a device that attaches to the streamer and has at least two wings extending away from the streamer. Thus, each bird constitutes an obstacle for a traditional cleaning device that most in use today cannot pass. Therefore, the cleaning range of these devices is limited to a portion of the streamer that lies between two adjacent birds.

To overcome this problem, an active cleaning device has been introduced and has the capability to clean the streamer between adjacent birds and to move back and forth between the birds, without human intervention. Thus, plural cleaning devices are located on a streamer, one for each pair of adjacent birds. Such an active cleaning device is described in U.S. Pat. No. 7,409,919. This cleaning device includes a turbine rotated by the water flow caused by the movement of the streamer through the water, and a drive element configured to convert the rotation of the turbine into motion of the cleaning device along the seismic streamer. The drive element includes wheels or other mechanisms that are in contact with and moving relative to the streamer. In order to reverse the motion from upstream (i.e., in the towing direction) to downstream (i.e., in a direction opposite the towing direction) the pitch of the turbine blades is changed. The disadvantage of this cleaning device is that the turbine and the drive train can be damaged by seaweed or fish line entangled on the moving parts dragged through the water. Additionally, since the drive elements are constantly in tight frictional contact (e.g., loaded by spring suspension) with the streamer, it may at times be difficult for the cleaning device to roll over the contaminants deposited on the streamer's outer surface, and it occasionally may be even impossible to pass obstacles with larger diameter, such as weights or bird collar overmolds that are often seen along streamer sections.

Further, the above solution uses tens, if not hundreds, of cleaning devices because such a cleaning device cannot move past an obstacle, i.e., the cleaning device operates only between two adjacent birds. Given the fact that a distance between two adjacent birds is between 150 and 350 m, a length of a streamer is between 8 and 15 km and a streamer spread includes up to 20 streamers, the number of cleaning devices may be around 1,000 for this configuration. This large number of cleaning devices adds an extra burden on the towing vessel, because each cleaning device is actuated by the water drag generated by towing the streamers.

Therefore, there is a need to develop streamer cleaning devices that operate with minimum burden on the towing vessel and which are capable of cleaning the entire streamer irrespective of obstacles present along the streamer surface.

### BRIEF SUMMARY OF THE INVENTION

Recently developed streamer positioning devices (birds) have rendered conventional streamer cleaning devices obsolete because it became impractical or impossible to pass over the birds. Cleaning devices and related methods according to various embodiments provide an efficient streamer-cleaning solution that cleans an entire streamer without worrying about the birds' presence.

According to an embodiment, there is a cleaning device for cleaning a marine element that is towed in water. The cleaning device includes first and second sections connected to each other so that the first section is configured to move relative to the second section; the first section including a first connecting mechanism configured to maintain the first section attached to the marine element; the second section including a second connecting mechanism configured to maintain the second section attached to the marine element; each of the first and second connecting mechanisms having corresponding rollers configured to contact the marine element and maintain the cleaning device centered relative to the marine element; and a cleaning unit configured to contact and clean the marine element.

According to another embodiment, there is a marine seismic cleaning system for cleaning a marine element. The system includes the marine element extending along a towing direction; an obstacle attached to the marine element and extending away from the marine element; a bypass rail attached to the marine element and configured to bypass the obstacle; and a cleaning device attached to the marine element and configured to follow the bypass rail when approaching the obstacle.

According to still another embodiment, there is a method for cleaning a marine element. The method includes attaching bypass rails across each obstacle of the marine element; attaching a cleaning device to a head end of the marine element; towing the marine element in water; and cleaning the marine element with the cleaning device while the marine element is towed in water. The cleaning device follows a corresponding bypass rail when encountering an obstacle.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a conventional marine seismic surveying system;

FIG. 2 illustrates a conventional passive streamer cleaning device;

FIG. 3 illustrates a cleaning system having a bypass rail according to an embodiment;

FIGS. 4A-B illustrate an attachment mechanism between a bypass rail and a streamer according to an embodiment;

FIG. 5 illustrates a cleaning device capable of following a bypass rail according to an embodiment;

FIG. 6 illustrates a connecting mechanism between a cleaning device and a streamer according to an embodiment;

FIG. 7 is a detailed view of the connecting mechanism;

FIGS. 8A-D illustrate how a cleaning mechanism switches from a streamer to a bypass rail and back while overcoming an obstacle on the streamer according to an embodiment;

FIG. 9 is a schematic diagram of a seismic survey system that uses a single cleaning device per streamer according to an embodiment;

FIG. 10 is a schematic diagram of a multi-level source;

FIG. 11 is a schematic diagram of a curved streamer; and

FIG. 12 is a flowchart of a method for cleaning an entire streamer according to an embodiment.

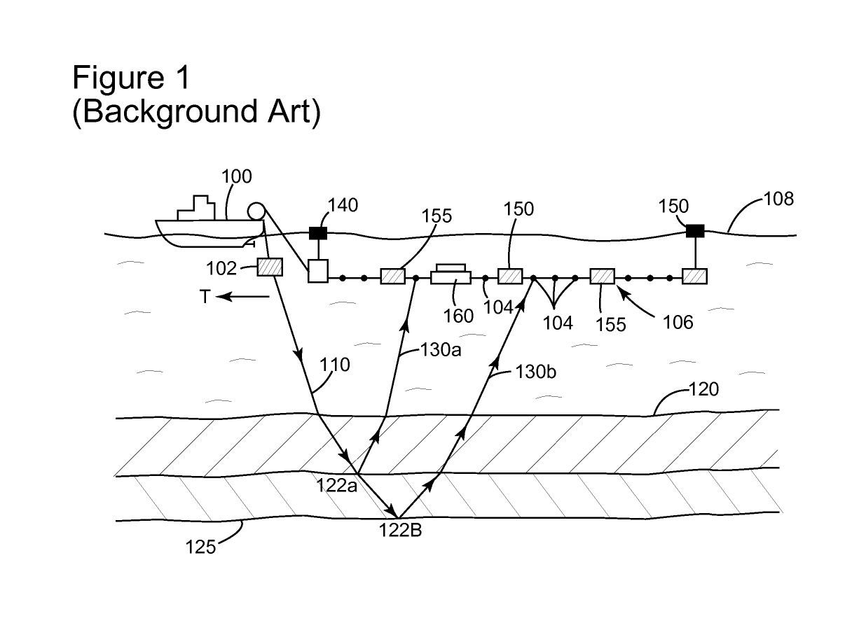

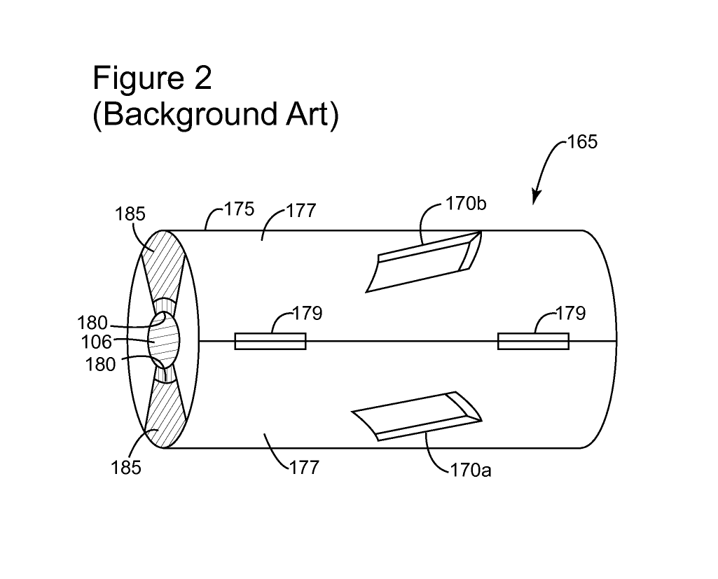

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a streamer-cleaning device used in marine seismic surveying. However, the embodiments to be discussed next are not limited to cleaning devices operating on streamers, but may be applied to portions of other cable-like structures related or not to streamers.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Cleaning devices, according to various embodiments described below, facilitate maintaining free of bio-fouling and other contaminants streamers towed underwater for recording seismic signals. As the number of streamers and their lengths are increasing to make seismic survey systems more efficient, placing tens, if not hundreds, of cleaning devices on the streamer spread only adds to the burden of towing such a massive structure underwater. Thus, a solution to this challenge is to have a single cleaning device per streamer and to design the cleaning device so it can pass any obstacle present on the streamer. In this way, the drag imposed on the towing vessel by the cleaning devices is substantially reduced while cleaning accumulated bio-fouling and other contaminants from the streamers. Such a novel cleaning device is now described with reference to the figures.

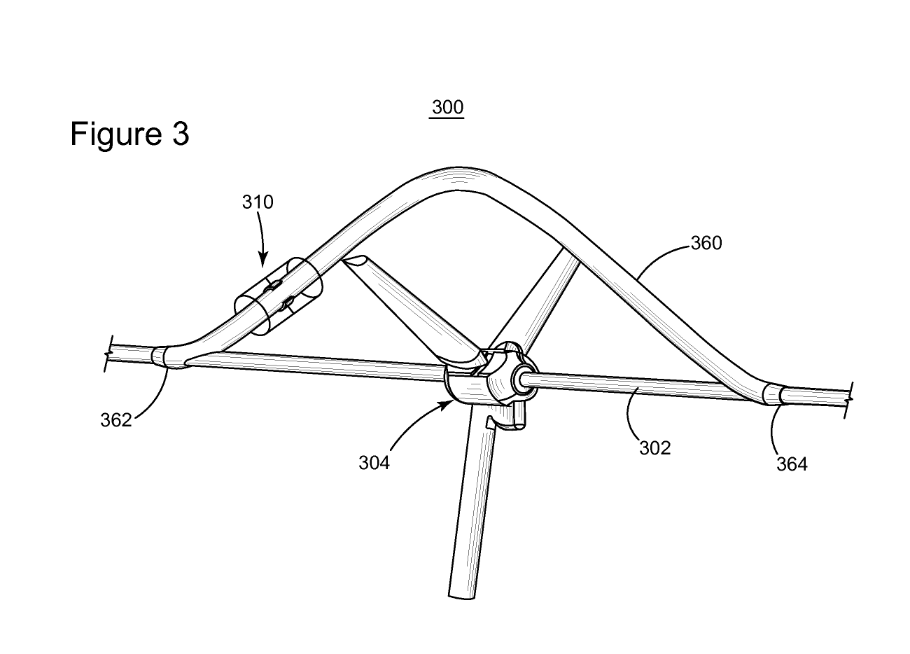

According to an embodiment illustrated in FIG. 3, a cleaning system 300 includes a cleaning device 310 and a bypass rail 360 placed along a streamer 302 over an obstacle 304, e.g., a bird. The specific bird shown in FIG. 3 has three wings, but a bird may have a variable number of wings. Also, an obstacle may include a streamer recovery device or other devices attached to the streamers as known by those skilled in the art. Bypass rail 360 is configured to be attached to streamer 302 at its two ends 362 and 364 so that the obstacle does not interfere at all with the bypass rail, i.e., there is no point on the bypass rail that touches the obstacle.

Cleaning device 310 is configured, as discussed later, to follow the streamer from one end to the other due to water flow and to follow the bypass rail when present instead of the streamer so that any obstacle associated with a bypass rail is avoided. In this way, a single cleaning device is able to clean the entire streamer. When the cleaning device arrives at the tail end of the streamer, it is recovered, for example, with a workboat and returned to the head end of the streamer to repeat the cleaning activity. The cleaning device may initially be attached to the streamer on the deck of the towing boat or from a workboat after the streamer is deployed in water. After cleaning the streamer, the cleaning device may be redeployed at the head end of the streamer with whatever frequency the conditions of the seismic survey dictate.

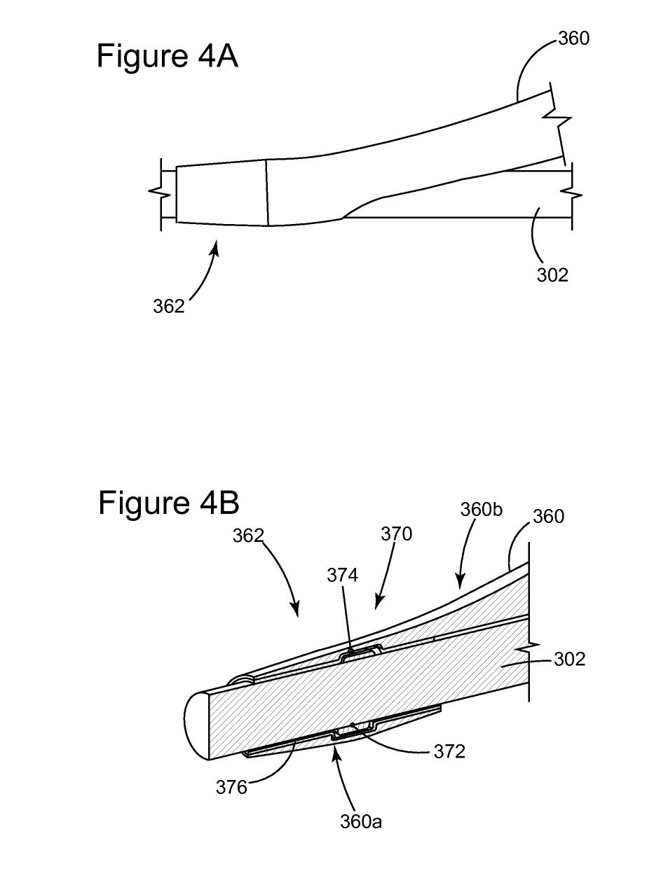

Details of the bypass rail and the cleaning device are now discussed in this order. FIG. 4A is an overview of an end 362 of the bypass rail 360 attached to streamer 302. Bypass rail may be made of one or more materials that make it flexible or not, for example, polyurethane, plastic, etc. In one application the bypass rail is flexible, i.e., it can slightly bend when pushed by the cleaning device or water currents. However, in another application, the bypass rail is rigid, i.e., it will not change its shape or size when reasonable force is applied. The material or materials used to form the bypass rail, which may include plastics, foam, metal and/or composites, may be selected so that the bypass rail has a desired buoyancy. For example, in one application the bypass rail is negatively buoyant (i.e., it naturally sinks). Because the attachment mechanism between the bypass rail and the streamer, to be discussed next with regard to FIG. 4B, allows the bypass rail to freely rotate around streamer 302, a negative buoyancy bypass rail will stay mainly below the streamer. However, if the bypass rail's buoyancy is positive, it will mainly stay above the streamer. Either negative or positive buoyancy combined with the freedom to rotate around the streamer enables the bypass rail to assume a preferred orientation, which may be advantageous for several reasons.

One reason relates to the cleaning device being able to follow the bypass rail instead of the streamer when approaching an obstacle. By designing the cleaning device to have and maintain a preferred orientation while traveling along the streamer, i.e., either above or below the streamer by controlling its buoyancy, a relative orientation between the bypass rail and the cleaning device may be achieved and maintained while traveling. For simplicity, consider that both the bypass rail and the cleaning device achieve the same predetermined orientation, for example, relative to the gravity. By placing a roller, to be discussed later, on the cleaning device so the roller always faces the bypass rail when encountering it, it is possible to make the cleaning device follow the bypass rail instead of the streamer when presented with a choice.

Another reason for maintaining the bypass rail with a given orientation underwater is to reduce possible noise it may introduce. In other words, it is desirable to prevent the bypass rail from swinging, which might create undesirable noise. Still another reason for having a bypass rail maintaining its orientation during the seismic survey is related to the fact that a streamer rotates along its longitudinal axis during the seismic survey, due to the presence of torsional stress in the towed streamer. Thus, it is desirable that a rotation of the streamer does not alter the orientation of the bypass rail.

The attachment mechanism that connects the bypass rail to the streamer is now discussed with reference to FIG. 4B. This figure illustrates attachment mechanism 370 at one end 362 of bypass rail 360. A similar mechanism is provided at the other end of the bypass rail. The illustrated attachment mechanism is just one possible approach, and those skilled in the art would recognize that other structures for the attachment mechanism may be used.

Attachment mechanism 370 includes a shoulder 372 formed on or attached to streamer 302. Shoulder 372 may be, for example, a collar attached on the streamer, for example, with a screw or bolt so the collar may be removed from the streamer if necessary. In another application, the shoulder may be an overmolding formed integrally or not with the streamer during the streamer's manufacture. Thus, shoulder 372 may be retrofitted to an existing streamer. Shoulder 372 is received by a mating recess 374 formed in the end 362 of bypass rail 360. Mating recess 374 may extend all the way around the streamer, i.e., the corresponding portion 360a of the bypass rail that accommodates the mating recess completely encircles the streamer. In this respect, note that bypass rail portion 360b only partially encircles streamer 302. Returning to portion 360a, it may be made out of two halves connected to each other by known means, e.g., screws. In one application, mating recess 374 together with shoulder 372 form a journal bearing. However, in another application, a more complex bearing 376 (e.g., journal bearing) may be provided between mating recess 374 and shoulder 372. In one application, the bearing may be made of PTFE (Polytetrafluoroethylen).

While the embodiment illustrated in FIGS. 4A and 4B shows a bypass rail capable of freely rotating around the streamer, it is also possible to prevent such rotation. For example, one or more screws may be inserted through the bypass rail into, for example, shoulder 372 to fix the bypass rail relative to the streamer.

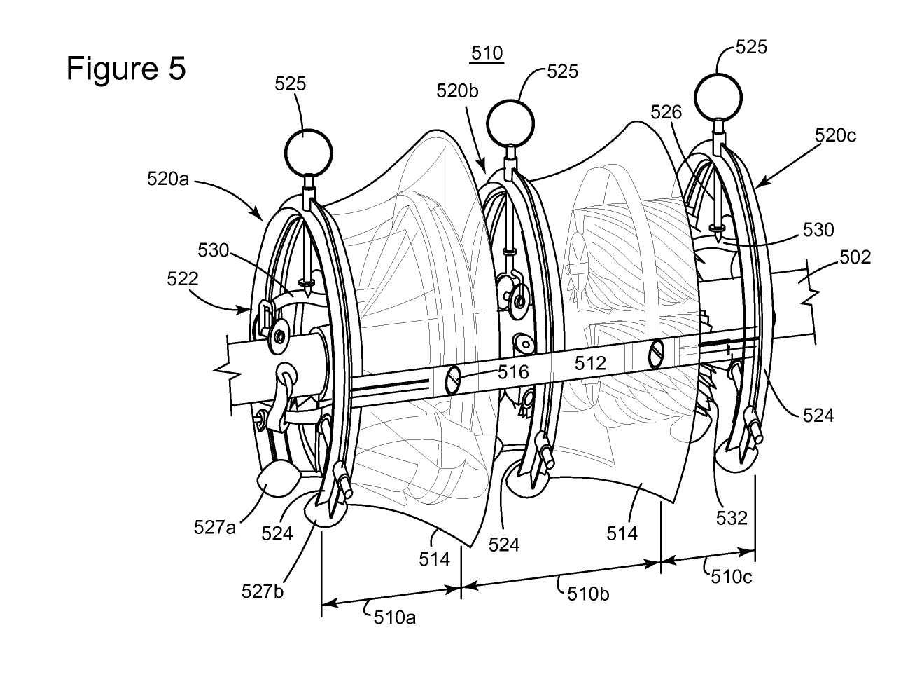

Next, a cleaning device 510 is illustrated, according to an embodiment, in FIG. 5. Cleaning device 510 is shown attached to streamer 502 and having three sections 510a-c, each having a corresponding connecting mechanism 520a-c. The number of sections and/or connecting mechanisms may vary depending on the size of the cleaning tool. For example, this number can vary between two and ten. In one application, one connecting mechanism 520b is attached to a body 512 of the cleaning device, and each connecting mechanism includes plural rollers 522 configured to roll along streamer 502.

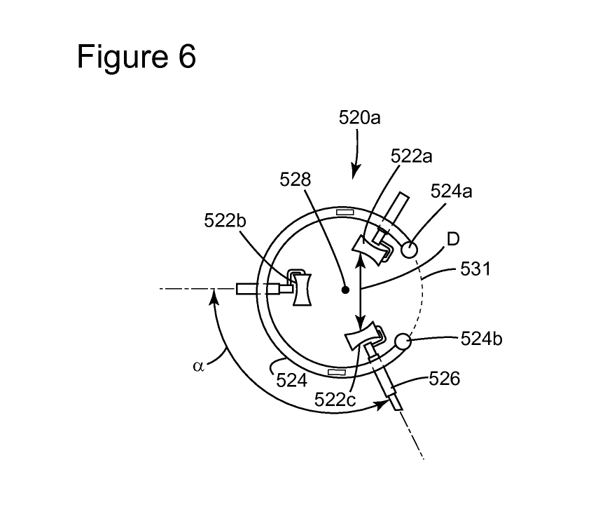

The embodiment illustrated in FIG. 5 has one connecting mechanism per section. Each connecting mechanism may include three rollers 522a-c as illustrated in FIG. 6. These rollers may be distributed symmetrically around streamer 502, which is missing in FIG. 6 for simplicity. Each roller 522 is attached to a frame 524 of the connecting mechanism with an adjustable support 526. In one application, adjustable support 526 may be screwed into frame 524 for adjusting a distance between each roller 522 and the center 528 of frame 524. Alternatively, adjustable support 526 may have a spring for biasing the roller on the streamer and another mechanism for retrieving the roller from the streamer.

Frame 524 may have a round form, similar, for example, to a circle from which an arc (indicated by dashed line) 531 is removed. The angle spanning the missing arc may be between 20 and 40 degrees, and it should be large enough to be able to receive streamer 302. In other words, when a cleaning device is attached to streamer 302, each connecting mechanism's frame needs to have an opening large enough to receive streamer 302. In one application, a distance D between peripheral rollers 522a and 522c, closest to ends 524a and 524b, respectively, of frame 524, is smaller than an external diameter of streamer 302. However, because frame 524 may be made of a slightly flexible material, when attached to a streamer, the two rollers 522a and 522c snap over the streamer so that central roller 522b also touches the streamer, thus, securing the cleaning device to the streamer. Alternatively, if the rollers are biased by corresponding springs, they can be retracted to accept the streamer. Further, the arrangement of rollers 522a-c also ensures that the cleaning device stays attached to the streamer and does not come off when moving along the streamer. In one application, an angle α between central roller 522b and a peripheral roller 522a or 522c may be between 90 and 170°.

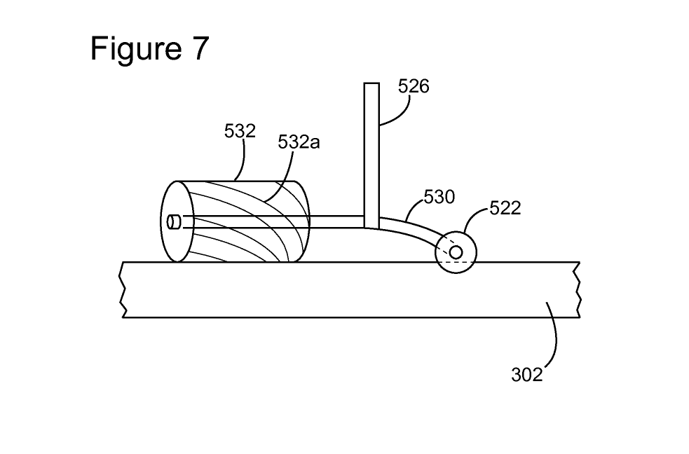

Returning to FIG. 5, both connecting mechanisms 520a and 520c may have rollers 522 attached directly to an axle 530, and this axle is attached to adjustable support 526. Axle 530 may have the purpose of also supporting a cleaning unit 532 configured to rotate about axle 530 for scraping any material deposited on streamer 502 with its blades 532a (see FIG. 7). FIG. 7 shows roller 522 having a groove that accommodates streamer 302 so that streamer 302 is partially located within roller 522. In other words, a shape of roller 522, according to this embodiment, is similar to a diabolo, i.e., an axle and two cups or discs attached to each other along the axle and the cups having their openings facing away from each other.

This specific shape of the rollers ensures that the cleaning device does not fall from the streamer and also that the cleaning device follows the bypass rail when faced with a choice of following the streamer or the bypass rail.

This last feature is also achieved because a relative orientation of the bypass rail and the cleaning device may be controlled during the cleaning process and, thus, a central roller 522b is oriented to always face the bypass rail. This may happen when both the bypass rail and the cleaning device have negative or positive buoyancy, but also when one has a positive buoyancy and the other has a negative buoyancy as long as their relative orientation is maintained constant during the cleaning operation. The cleaning device may be oriented to achieve this condition by distributing its weight in an appropriate manner, for example, its center of mass below the streamer's center of mass when the bypass rail is below the streamer, and the opposite when the bypass rail is above the streamer.

Still with regard to FIG. 5, connecting mechanism 520b may be different from connecting mechanisms 520a and 520c in the sense that rollers 522 are directly attached to adjustable support 526 because no cleaning unit is present in the connecting mechanism 520b. One or more of frames 524 may have a float 525 place next to the central roller 522b for the purpose of achieving the desired orientation of the entire cleaning device. Thus, float 525 may be made of a material having positive buoyancy. To further enhance this function, weights 527a and 527b may be attached to ends 524a and 524b of frame 524 as also illustrated in FIG. 5.

Cleaning device 510 may also include one or more propulsion mechanisms 514, e.g., a surface extending away from the streamer, which interacts with the water flow for actuating the device along the streamer. Propulsion mechanism 514 may be attached to the cleaning device's main body 512 or to one of the connecting mechanisms 520a-c. More than one propulsion mechanism may be used. FIG. 5 shows two propulsion mechanisms 514 but this number is not intended to restrict the invention. Main body 512 may be flexibly connected to connecting mechanisms 520a and 520c, for example, through a hinge 516 or similar articulated connection so that, when departing from the streamer to follow the bypass rail, each connecting mechanism remains in continuous contact with either the streamer or the bypass rail.

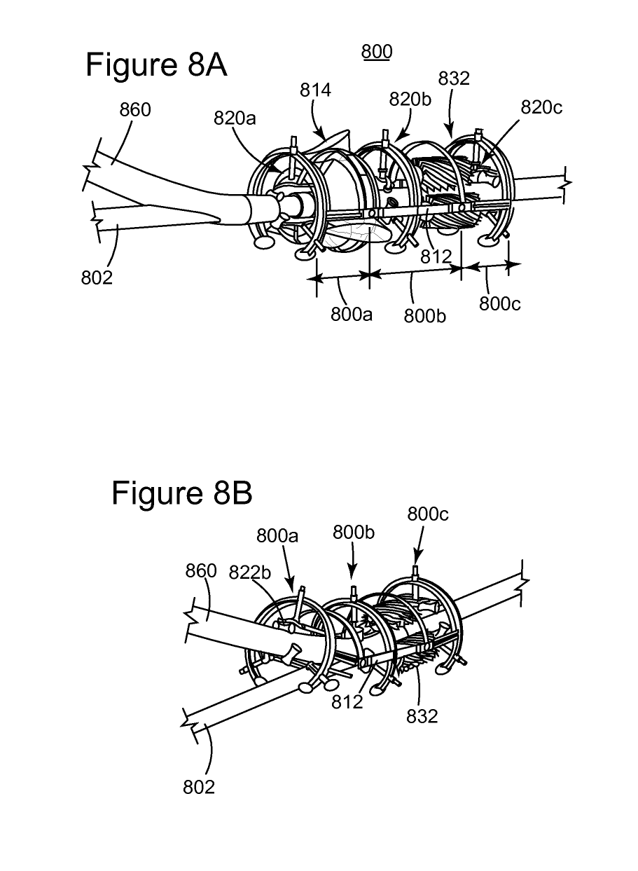

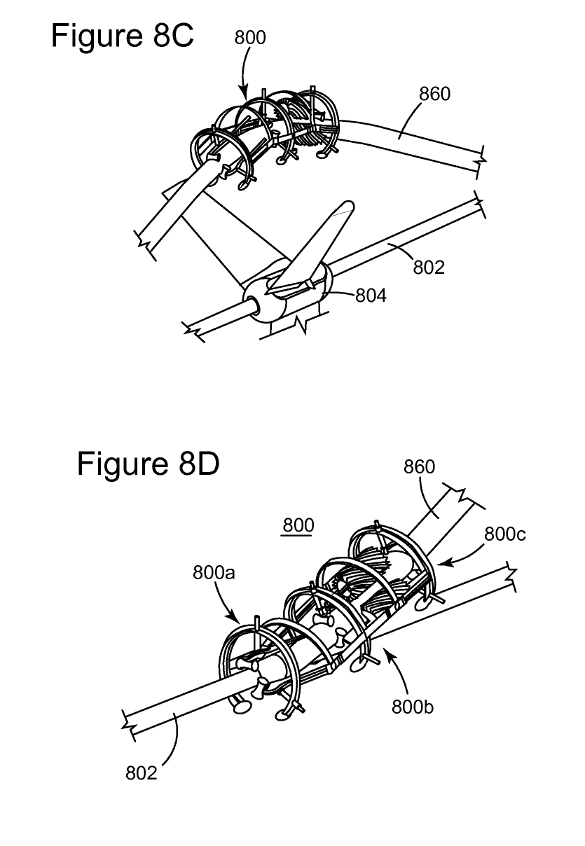

This concept of having the cleaning device capable of being in permanent contact with both the streamer and bypass rail while switching from one to another is illustrated in FIGS. 8A-D. This is possible because the cleaning device is similar to a caterpillar, i.e., it has two or more sections connected to each other, each section with the capability to have a different spatial orientation than an adjacent section. FIG. 8A shows a cleaning device 800 having three sections 800a-c. First section 800a has one or more vanes 814 for interacting with the water flow and propelling the entire cleaning device from one end of the streamer to the other end. First section 800a also includes a first connecting mechanism 820a. Second section 800b includes the main body 812 of the device, to which the first and third sections are rotatably attached. As shown in FIG. 8B, first section 800a, while engaging bypass rail 860, rotates relative to body 812 to follow the bypass rail. Also note in FIG. 8B that central roller 822b is aligned with bypass rail 860 and follows it so that the cleaning device moves away from streamer 802. Thus, as long as the central roller is oriented to face the bypass rail, the cleaning device always follows the bypass rail when encountering an obstacle that has a bypass rail. FIG. 8A also shows third section 800c, which includes, besides a third connecting mechanism 820c, a cleaning unit 832. Third section 800c is also connected to main body 812 and capable of rotating relative to the second section. Because of this rotating property of one section relative to an adjacent section, the cleaning device can have each section in full contact with either the bypass rail or the streamer while switching from one another. Although the figures show the cleaning device having three sections, the novel features discussed in this application are applicable to a cleaning device having two or more than three sections.

FIG. 8C shows cleaning device 800 fully engaged with bypass rail 860, and bird 804 being successfully passed by the cleaning device, while FIG. 8D shows the first section 800a returning to streamer 802. Cleaning unit 832 may have other components than those shown in the figures, and it may also be connected to any of the cleaning device's sections. More than one cleaning unit may be used. Cleaning units with different functions may be attached to the cleaning device, for example, a cleaning unit that removes deposits from the streamer, a cleaning unit that applies a substance (e.g., a biocide substance) to the streamer, a unit that tests the integrity of the streamer, a diagnostic tool, etc.

Those skilled in the art would recognize that the cleaning device described above may be provided with a motor and associated logic so that when the cleaning device arrives at the tail end of the streamer, the associated logic activates the motor so the cleaning device returns by itself to the streamer's head end. Other cleaning device modifications may be implemented, such as having adjustable vanes that may be rotated to take advantage of the water flow and return the cleaning device to the head end of the streamer without the need of a motor.

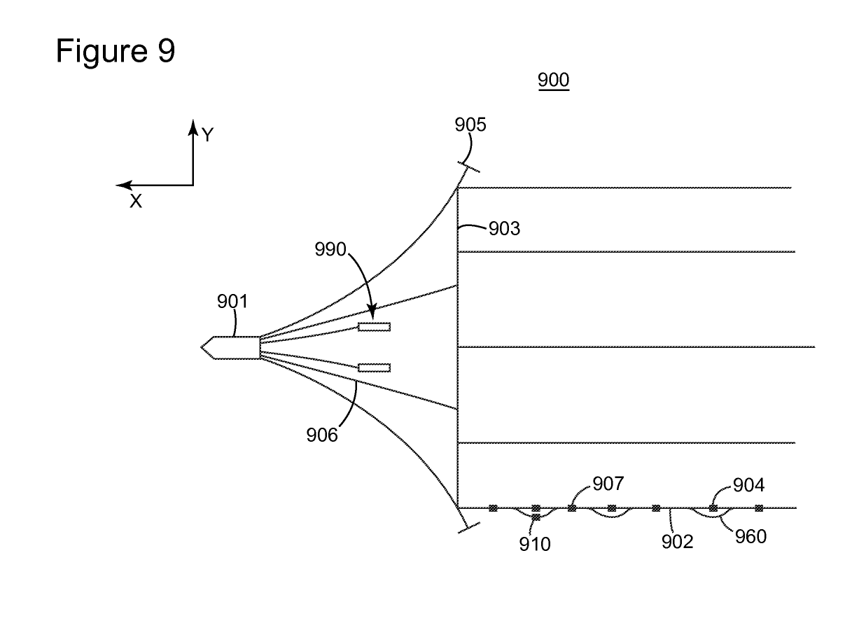

A seismic survey system 900 having one or more of the cleaning devices discussed above is illustrated in FIG. 9. System 900 includes a vessel 901 that tows along an inline direction X plural streamers 902. Streamers 902 are maintained at desired positions along a cross-line direction Y by separation ropes 903. These ropes are maintained under stress by using, for example, deflectors 905. Each streamer includes detectors 907, which can be single or multicomponent and can include hydrophones, geophones, accelerometers, or a combination of them. Each streamer may include various obstacles 904 paired with corresponding bypass rails 960 so that cleaning device 910 may pass the obstacles. With the bypass rails, a single cleaning device per streamer may be used. Towing vessel 901 also tows a source array 990 configured to generate seismic waves.

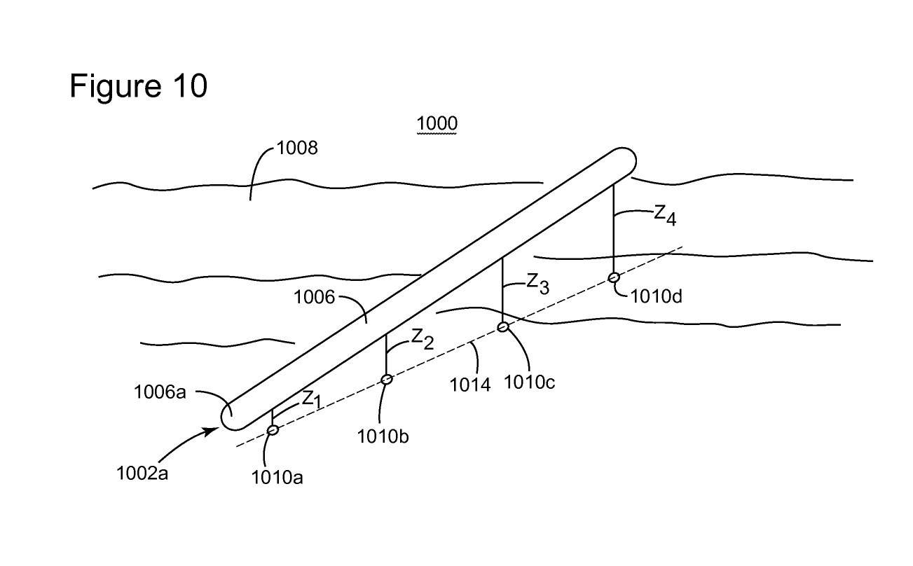

Source array 990 may be a multi-level source as illustrated in FIG. 10. A multi-level source 1000 has one or more sub-arrays. The first sub-array 1002 has a float 1006 configured to float at the water surface 1008 or underwater at a predetermined depth. Plural source points 1010a-d are suspended from the float 1006 in a known manner. A first source point 1010a may be suspended closest to the head 1006a of float 1006, at a first depth z1. A second source point 1010b may be suspended next, at a second depth z2, different from z1. A third source point 1010c may be suspended next, at a third depth z3, different from z1 and z2, and so on. FIG. 10 shows, for simplicity, only four source points 1010a-d, but an actual implementation may have any desired number of source points. In one application, because the source points are distributed at different depths, they are not simultaneously activated. In other words, the source array is synchronized, i.e., a deeper source point is activated later in time (e.g., 2 ms for 3 m depth difference when the speed of sound in water is 1,500 m/s) such that corresponding sound signals produced by the plural source points coalesce and, thus, the overall sound signal produced by the source array appears to be a single sound signal.

Depths z1 to z4 of the source points of the first sub-array 1002 may obey various relationships. In one application, the depths of the source points increase from the head toward the tail of the float, i.e., z1<z2<z3<z4. In another application, the depths of the source points decrease from the head to the tail of the float. In another application, the source points are slanted, i.e., provided on an imaginary line 1014. In still another application, the line 1014 is a straight line. In yet another application, the line 1014 is a curved line, e.g., part of a parabola, circle, hyperbola, etc. In one application, the depth of the first source point for the sub-array 1002 is about 5 m, and the greatest depth of the last source point is about 8 m. In a variation of this embodiment, the depth range is between 8.5 and 10.5 m or between 11 and 14 m. In another variation of this embodiment, when the line 1014 is straight, the depths of the source points increase by 0.5 m from one source point to an adjacent source point. Those skilled in the art would recognize that these ranges are exemplary and these numbers may vary from survey to survey. A common feature of all these embodiments is that the source points have variable depths so a single sub-array exhibits multiple-level source points.

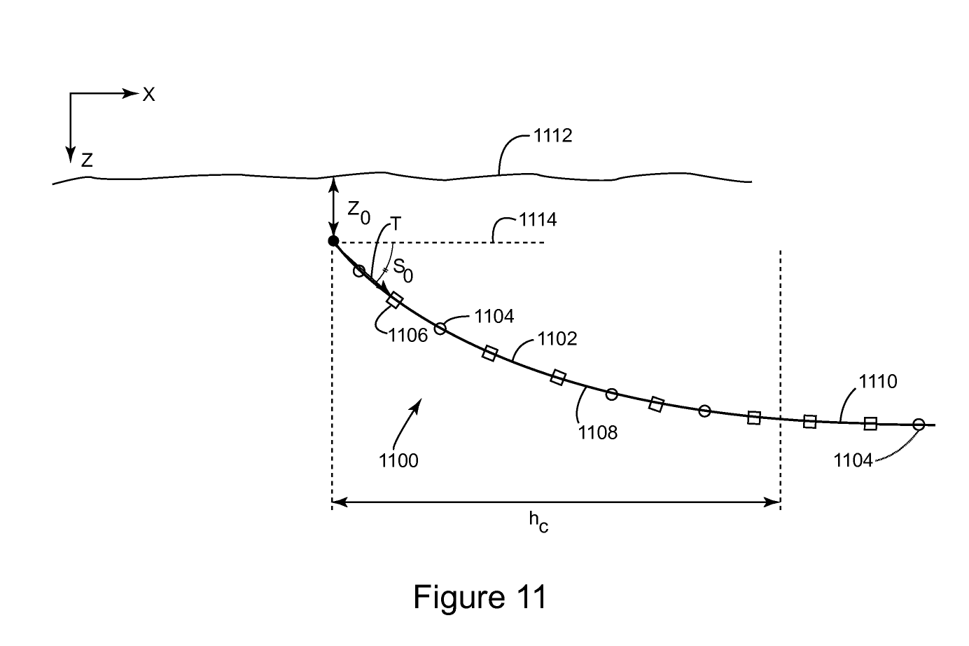

Streamer 902 illustrated in FIG. 9 may have different profiles. In this sense, the streamers may be horizontal or slanted or have a curved profile as illustrated in FIG. 11. A curved streamer 1100 as shown in FIG. 11 includes a body 1102 having a predetermined length, plural detectors 1104 provided along the body, and plural birds 1106 provided along the body for maintaining the selected curved profile. The streamer is configured to flow underwater when towed so that the plural detectors are distributed along the curved profile. The curved profile may be described as a parameterized curve, e.g., a curve described by (i) a depth z₀ of a first detector (measured from the water surface 1112), (ii) a slope s₀ of a first portion T of the body with an axis 1114 parallel with the water surface 1112, and (iii) a predetermined horizontal distance h_{c} between the first detector and an end of the curved profile. Note that the entire streamer does not have to have the curved profile. In other words, the curved profile should not be construed to always apply to the entire length of the streamer. While this situation is possible, the curved profile may be applied only to a portion 1108 of the streamer. In other words, the streamer may have (i) only a portion 1108 having the curved profile or (ii) a portion 1108 with the curved profile and a portion 1110 with a flat profile, the two portions being attached to each other.

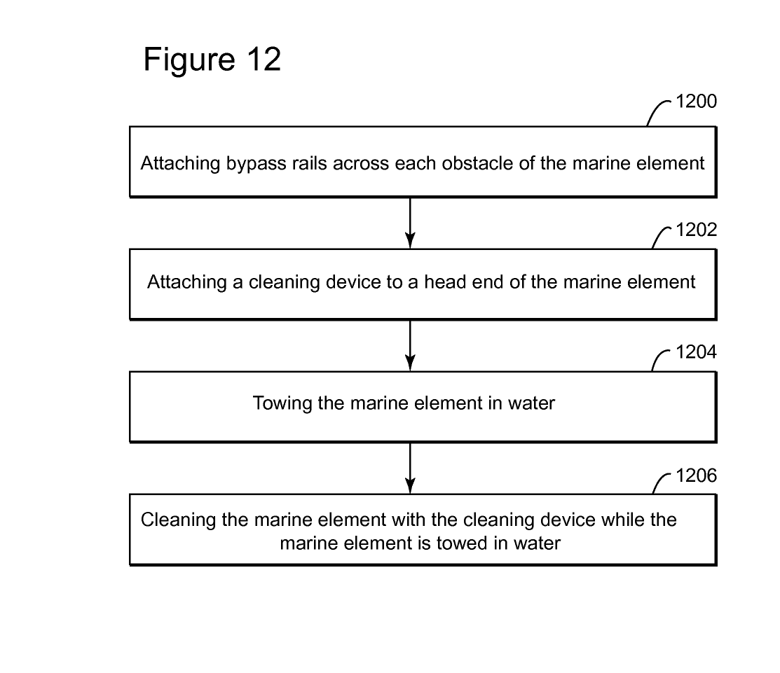

A method for cleaning a marine element with one of the cleaning devices discussed above is now described with reference to FIG. 12. The method includes a step 1200 of attaching bypass rails across each obstacle of the marine element, a step 1202 of attaching a cleaning device to a head end of the marine element, a step 1204 of towing the marine element in water, and a step 1206 of cleaning the marine element with the cleaning device while the marine element is towed in water, wherein the cleaning device follows a corresponding bypass rail when encountering an obstacle.

The disclosed embodiments provide a cleaning device for cleaning an entire streamer that has various obstacles. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A cleaning device for cleaning a marine element that is towed in water, the cleaning device comprising:
first and second sections connected to each other so that the first section is configured to move relative to the second section;
the first section including a first connecting mechanism configured to maintain the first section attached to the marine element;
the second section including a second connecting mechanism configured to maintain the second section attached to the marine element;
each of the first and second connecting mechanisms having corresponding rollers configured to contact the marine element and maintain the cleaning device centered relative to the marine element; and
a cleaning unit configured to contact and clean the marine element.

2. The cleaning device of claim 1, where each of the first and second connecting mechanism includes three rollers.

3. The cleaning device of claim 2, wherein each roller is a diabolo.

4. The cleaning device of claim 1, wherein the first connecting mechanism includes adjustable support, each attached to a corresponding roller.

5. The cleaning device of claim 1, wherein the second connecting mechanism includes axles, each axle being attached to an adjustable support, and each axle having at one end a roller and at the other end a cleaning unit.

6. The cleaning device of claim 1, wherein each of the first and second mechanism includes a frame having a shape of a circle from which an arc is missing.

7. The cleaning device of claim 6, wherein a distance D between two rollers located closest to ends of the frame is smaller than an outer diameter of the marine element.

8. The cleaning device of claim 1, further comprising:
a third section connected to the first section, wherein the third section is configured to move relative to the first section.

9. The cleaning device of claim 1, wherein each section can rotate relative to an adjacent section.

10. The cleaning device of claim 1, wherein the first section has a propulsion mechanism that actuates the cleaning device along the marine element.

11. A marine seismic cleaning system for cleaning a marine element, the system comprising:
the marine element extending along a towing direction;
an obstacle attached to the marine element and extending away from the marine element;
a bypass rail attached to the marine element and configured to bypass the obstacle; and
a cleaning device attached to the marine element and configured to follow the bypass rail when approaching the obstacle.

12. The system of claim 11, wherein the bypass rail is configured to rotate around the marine element.

13. The system of claim 12, wherein the bypass rail has a negative buoyancy so that it extends below the marine element.

14. The system of claim 13, wherein the cleaning device has a negative buoyancy so that it extends below the marine element.

15. The system of claim 14, wherein the cleaning device has multiple sections configured to move one relative to another.

16. The system of claim 14, wherein each section of the cleaning device has a corresponding lower roller that contacts the marine element from below so that when the cleaning device encounters the bypass rail, the lower roller pushes the cleaning device away from the marine element on the bypass rail.

17. The system of claim 16, wherein each roller is a diabolo.

18. The system of claim 11, wherein the marine element is a streamer.

19. The system of claim 11, wherein the cleaning device includes a cleaning unit that cleans the marine element and the obstacle is a bird.

20. A method for cleaning a marine element, the method comprising:
attaching bypass rails across each obstacle of the marine element;
attaching a cleaning device to a head end of the marine element;
towing the marine element in water; and
cleaning the marine element with the cleaning device while the marine element is towed in water,
wherein the cleaning device follows a corresponding bypass rail when encountering an obstacle.
